(19) United States
(12) Patent Application Publication
(10) Pub. No.: US 2005/0200549 A1
(43) Pub. Date: Sep. 15, 2005

(54) Optimal Tapered Band Positioning to Mitigate Flare-End Ringing of Broadband Antennas

(75) Inventors: Scott Randall Thompson, Hermosa, SD (US); Bernt Askild Askildsen, Rapid City, SD (US)

Correspondence Address: RealTronics Corporation;Scott Thompson, 322 Canal Street, Rapid City, SD, 57701-2680, US

(73) Assignee: REALTRONICS CORPORATION, Rapid City, SD (US)

(21) Appl. No.: 10/906,997

(22) Filed: Mar. 15, 2005

Related U.S. Application Data
(60) Provisional application No. 60/553,060, filed on Mar. 15, 2004.

(51) Int. Cl. H01Q 13/00

(52) U.S. Cl. 343/795; 343/793

(57) ABSTRACT

A novel approach is disclosed that mitigates flare-end ringing induced distortion of impulse signals that are transmitted from an electromagnetic radiator. Conventional tapering suppresses energy in the return path by impedance loading the antenna element at the expense of reduced radiation efficiency. This disclosure presents a method that balances the trade-off between radiation efficiency and return path energy suppression while it simultaneously minimizes taper induced signal distortion effects on the front edge of the transmitted impulse. The balance between radiation efficiency, end-fire ringing, and impulse distortion is achieved by placing impedance loading at only at or near the second half of the antenna element. Recent disclosures show the advantage of determining the position of each band through mathematical calculation and by subsequently removing select bands near the feed point to move the reflected pulse away from the front-edge of the transmitted impulse. This disclosure will show that optimal placement of the first tapered band is substantially more critical. The reflection caused by this interface must reach the original impulse at a position that will minimally interfere with its front edge.

### CROSS-REFERENCE TO RELATED APPLICATIONS

Current US Class: 343/793, 343/807, 343/845
International Class: H01Q 001/38, 48
Field of Search: 250/216, 342/379, 343/727, 730, 739, 740, 775, 777, 793, 795, 807, 813, 814, 815, 819, 820, 826, 828, 841, 845, 912, 913

### OTHER PUBLICATIONS

[1] R. L. Carrel, “The characteristic impedance of two infinite cones of arbitrary cross section,” IEEE Trans. Antennas Propagation, vol. AP-6, no. 2, pp. 197-201, 1958.
[2] T. T. Wu and R. W. P. King, “The cylindrical antenna with nonreflecting resistive loading,” IEEE Trans. Antennas Propagation, vol. 13, no. 3, pp. 369-373, 1965.
[3] Wu et al., “The Cylindrical Antenna with Nonreflecting Resistive Loading”, IEEE Transactions on Antennas and Propagation, vol. AP-13, No. 3, pp. 369-373, May 1965.
[4] Shen, “An Experimental Study of the Antenna with Nonreflecting Resistive Loading”, IEEE Transactions on Antennas and Propagation, vol. AP15, No. 5, Sep. 1967, pp. 606-611.
[5] Kanda, A Relatively Short Cylindrical Broadband Antenna with Tapered Resistive Loading for Picosecond Pulse Measurements, vol. AP 26, No. 3, May 1978, pp. 439-447
[6] Rao et al., “Wideband HF Monopole Antennas with Tapered Resistivity Loading,” presented at Milcom'90, 1990 IEEE Military Comm. Conf., Sep. 30-Oct. 3, 1990, Monterey, Calif.
[7] Rao, “Optimized Tapered Resistivity Profiles for Wideband HF Monopole Antenna,” presented at 1991 IEEE Ant. & Prop. Soc. Intl. Symp., London, Ontario, Canada
[8] Maloney et al., “Optimization of a Resistively Loaded Conical Antenna for Pulse Radiation,” IEEE APS Symposium proceedings, Jul., 1992
[9] Clapp, “A Resistively Loaded, Printed Circuit, Electrically Short Dipole Element for Wideband Array Applications”, IEEE, May 1993, pp. 478-481
[10] K. L. Shlager, G. S. Smith and J. G. Maloney, “Optimization of bow-tie antennas for pulse radiation,” IEEE Trans. Antennas Propagation, vol. 42, no. 7, pp. 975-982, 1994.

[11] Amert, T., Wolf, J., Albers, L., Palecek, D., Thompson, S., Askildsen, B., Whites, K. W., “Economical Resistive Tapering of Bowtie Antennas,” IEEE Antennas and Propagation Society Symposium, ISIU RSM, Monterey, Calif., Page(s): 1772-1775, Jun. 20-25, 2004

### STATEMENT REGARDING FEDERALLY SPONSORED RESEARCH OR DEVELOPMENT

None.

### REFERENCE TO SEQUENCE LISTING, A TABLE, OR A COMPUTER PROGRAM APPENDIX

None.

### BACKGROUND OF THE INVENTION

End-fire or flare-end ringing occurs when a signal bounces back-and-forth between the feed-point and the flare end of an antenna. This is a particularly prominent problem for ultra-wideband antennas such as that described in U.S. Pat. Nos. 3,369,245 and 3,984,838 and by Carrel in [1]. The phenomenon, illustrated graphically in FIG. 1, introduces noise into the antenna that is generally larger than any target signal until the ringing effect attenuates. A primary challenge to antenna design is to mitigate this problem without distorting the rising edge of the transmitted pulse or destabilizing the ultra wide band impedance characteristics of the antenna. Prior art employed combinations of flair end lump loading and impedance tapering to suppress end-fire ringing at the cost of rising edge distortion and poor radiation efficiency; [2-5], and U.S. Pat. No. 4,679,007.

The quest for broadband antennas capable of effectively transmitting impulse signals or multiple carrier waves has been ongoing for nearly a century and is documented through prior art and public disclosure including the dipole antenna, U.S. Pat. No. 4,125,840; resistive loaded antennas [2-4,6-8]; tapered antennas, [5-7] and U.S. Pat. Nos. 4,642,645 and 4,803,495; printed circuit board antennas, [9] and U.S. Pat. No. 4,758,843; side-lobe suppression antennas, U.S. Pat. No. 4,376,940; and lump loading for maximal energy transfer, U.S. Pat. No. 4,679,007.

More recent work by Shlager, Smith and Maloney applied this technique to bowtie antennas [10]. They showed that resistive tapering reduces the return signal of an ultra wideband (UWB) signal pulse. To implement such an antenna, they constructed a bowtie antenna from three sections of material with varying conductivity. The conductivities were chosen to meet the requirements for the taper in [2].

Lump loading alone does not mitigate the problem of end-fire ringing during the first several cycles and consequently target detection is impeded in the near field. Tapered antennas address the problem of near field target detection very effectively by distributing bands of impedance across the antenna to convert the ringing energy into heat. However, this payoff is afforded at the expense of a substantial drop in radiation efficiency and an accompanying requirement for more powerful transmitter hardware. Moreover, the discrete interface at each tapered band creates parasitic side-lobes and induces reflections near the feed point that distorts the rising edge of the transmitted pulse. This is a particularly prominent problem for target identification systems because the rising edge of the pulse carries the target characteristics information of a target reflection and is only useful if it has very low levels of distortion.

Several recent designs were patented to address the deficiencies of the above listed prior art including a low side-lobe resistive reflector antenna, U.S. Pat. No. 5,134,423; a low profile antenna, U.S. Pat. No. 5,184,143; a top loaded Bow-Tie antenna, U.S. Pat. No. 6,323,821; a closely coupled directive antenna, U.S. Pat. No. 6,025,811; and a tapered, folded monopole antenna, U.S. Pat. No. 6,774,858. Each of these prior disclosures employed unique methods to mitigate known problems of the expired patents that were described earlier, yet none fully and simultaneously address the problems of end-fire ringing, consistent impedance characteristics, and distortion on the rising edge of the transmitted pulse.

The position of each tapered band in the economically resistive tapered bow-tie antenna that was disclosed by Amert, et al., in [11] was determined through ad-hoc mathematical adjustments between resistive values and the distance between each of the 8 bands shown at 35 and the feed point of the antenna. Owing to the negligible resistance values at close distances to the feed point, the first two tapered interfaces were removed. Simulations showed that this approach improved antenna performance by moving the first reflection away from the transmitted impulse, which eliminated some of the distortion on the front-edge of the impulse. This invention improves the approach cited in [11] by optimally positioning the first band so that the first-band reflection induced distortion on the front-edge of the transmitted impulse is almost completely eliminated.

### BRIEF SUMMARY OF THE INVENTION

This invention improves prior art by combining impedance matching with wave propagation techniques to achieve marginal flare-end ringing. This is achieved by changing the distribution of impedance tapering throughout the antenna and although it is depicted on a bow-tie antenna only to illustrate the concept, the technique is effective on any shape of impedance tapered antennae. In particular, the first impedance band is optimally placed at a position on each antenna leaf that minimizes interference between the front edge of the transmitted impulse and the reflected pulse that is generated by the discrete interface. This balancing strategy reduces the radiation efficiency for lower signal frequency components, which improves the impedance characteristics and filter response of the antenna. This invention further eliminates rising edge pulse distortion by moving the reflection from the first band away from the front edge of the impulse. The approach provides an optimal balance between radiation efficiency, end-fire ringing, and signal distortion.

### BRIEF DESCRIPTION OF THE SEVERAL VIEWS OF THE DRAWING

The invention is depicted in the below listed figures in the form of a bow-tie antenna only to illustrate the concept of this invention and how this invention works. The background, concept, and general technique that is described by the below listed figures and by this disclosure is effective on any shape of impedance tapered antennae. The following and other features of the present invention will be more readily apparent from the following detailed description and drawings of illustrative embodiments of the invention in which:

FIG. 1A: Is a plan-view of a conventional bow-tie antenna.

FIG. 1B: Is an illustration of the impulse ringing behavior of a conventional bow-tie antenna.

FIG. 2A: Is a plan-view of a lump resistor loaded conventional bow-tie antenna.

FIG. 3A: Is an illustration of the application of surface mount resistors on a tapered band antenna.

FIG. 3B: Is an illustration of the impulse behavior of an evenly distributed tapered bow-tie antenna.

FIG. 4: Is a plan view of a tapered antenna that uses surface mount resistors; the first tapered band is removed.

FIG. 5A: Is a plan view of a tapered antenna with the bands positioned for optimal performance.

FIG. 5B: Is an illustration of the impulse behavior of an optimally tapered antenna.

### DETAILED DESCRIPTION OF THE INVENTION

This invention is related to the improvement of antennas that are capable of transmitting an impulse signal by providing a method that balances radiation efficiency, end-fire ringing, and impulse distortion to improve the wide band impedance characteristics and wave reflections on the surface of an antenna. This novel approach was first published in [11] with an improvement to [10] that included removal of the first two impedance tapered bands. The position of each tapered impedance interface in [11], including the position of the first two bands that were removed from the antenna, was based on traditional and widely published mathematical calculations on the subject [9]. This invention discloses a novel improvement to [10] and [11] that optimally positions the first interface, most often in the half of the antenna that is closest to the flare-end, to eliminate the occurrence of interference from the interface induced pulse reflection before the front edge of the feed point impulse is transmitted from the antenna. This improvement is particularly important for radar systems that characterize targets since the information that characterizes a target is found from relatively noise-free reflections that stem from the first half of the transmitted impulse.

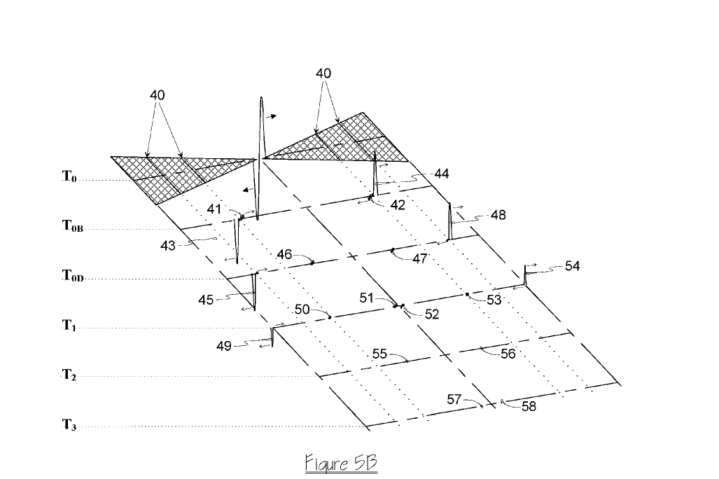

The invention is disclosed through a series of drawings that use a conventional broad band bow-tie antenna as a model. These illustrations do not limit the scope of the proposed invention to bow-tie antennas; the disclosed technique will improve the performance of any type or shape of broad band antenna. Assembly of this invention is illustrated by example in FIG. 5 on an unshielded bow-tie structure that is not lump loaded. This example does not restrict the disclosed invention to antennas that are not lump loaded or those that do not use back-shields. The resistive interfaces, indicated by gaps in the conductive material, can be fabricated from any conductive, resistive, dielectric, capacitive, inductive, or any other material that can alter the impedance of the interface or the impedance characteristics of the antenna.

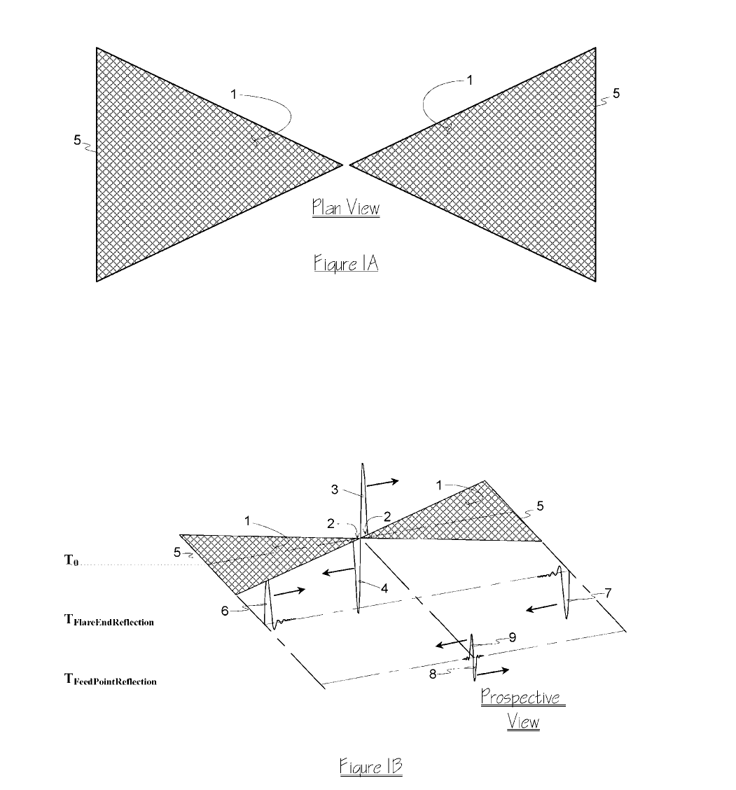

When a conventional broadband (Bow-Tie) antenna of the type shown at 1 in FIG. 1 is excited at the feed-point 2 by a sharp electric signal, the resulting positive 3 and negative 4 halves of the impulse propagate towards the flare-end of each antenna leaf 5 at time T₀(10). As the signal components reach the flare-end of each leaf (6 and 7) they are partially reflected back toward the feed-point 1. As the reflection from each component of the signal arrives at the feed-point (8 and 9) they are again partially reflected toward the flare-end. The signal components are iteratively reflected back and forth between the feed-point at time T_{FeedpointReflection}(11) and the flare-ends at time T_{FlareEndReflection}(12) of each antenna leaf until the signal attenuates after several iterations; the phenomenon is known as antenna ringing. The resulting noise impedes signal reception until the ringing signal attenuates below the operable noise floor of the radar.

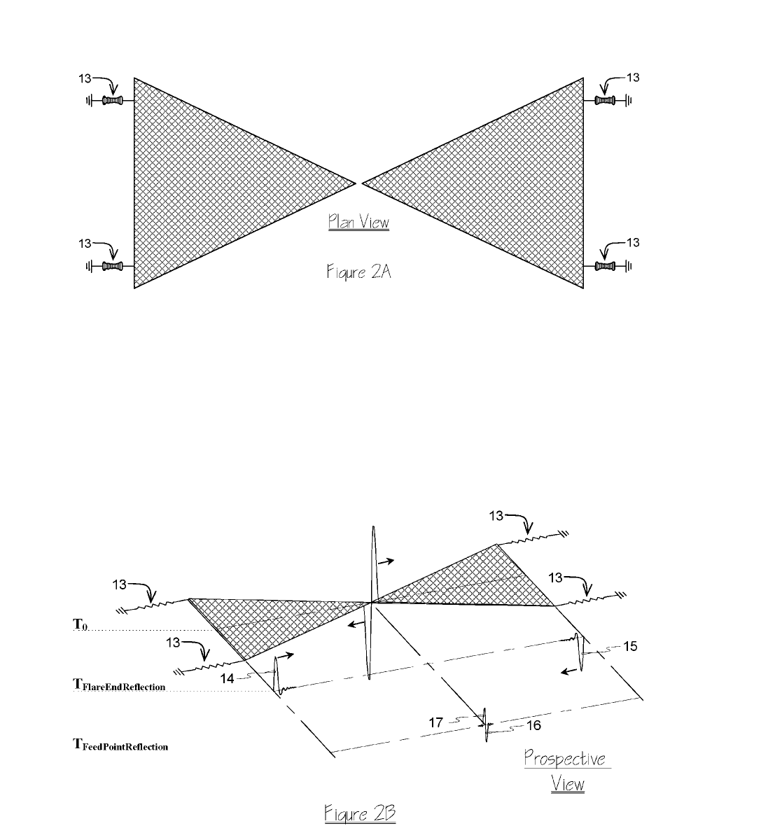

Prior discoveries showed that the application of lump loaded resistors 13 to the flare-end of each antenna element moderately suppresses antenna ringing by creating a partial impedance balance on the antenna at a select band of frequencies within the effective spectral operating range of the antenna. The improved impedance match enables a greater portion of the non-radiated energy to flow through the resistors and to a common system ground. In this example an impulse signal originates at the feed-point and travels toward the flare-end of each leaf at time T₀ just as it did in the illustration that was shown in FIG. 1. Lump loading does not provide matched impedance over the entire operable frequency range of the antenna and consequently some of the energy in the signal that reaches the flare-end of each leaf at points 14 and 15 is partially reflected back toward the feed-point. Nonetheless, the amplitude of the reflected signal that reaches the feed-point at 16 and 17 in FIG. 2 is much lower than that shown in FIG. 1 (8 and 9). The amplitude and polarization of each reflection will vary with the change of effective impedance at the lump-loaded flare-end interface. The ringing behavior of the lump loaded antenna is similar to an antenna without lump loading with the added benefit of a reduction in energy each time the signal is reflected between the feed-point and the flare-end of each antenna leaf.

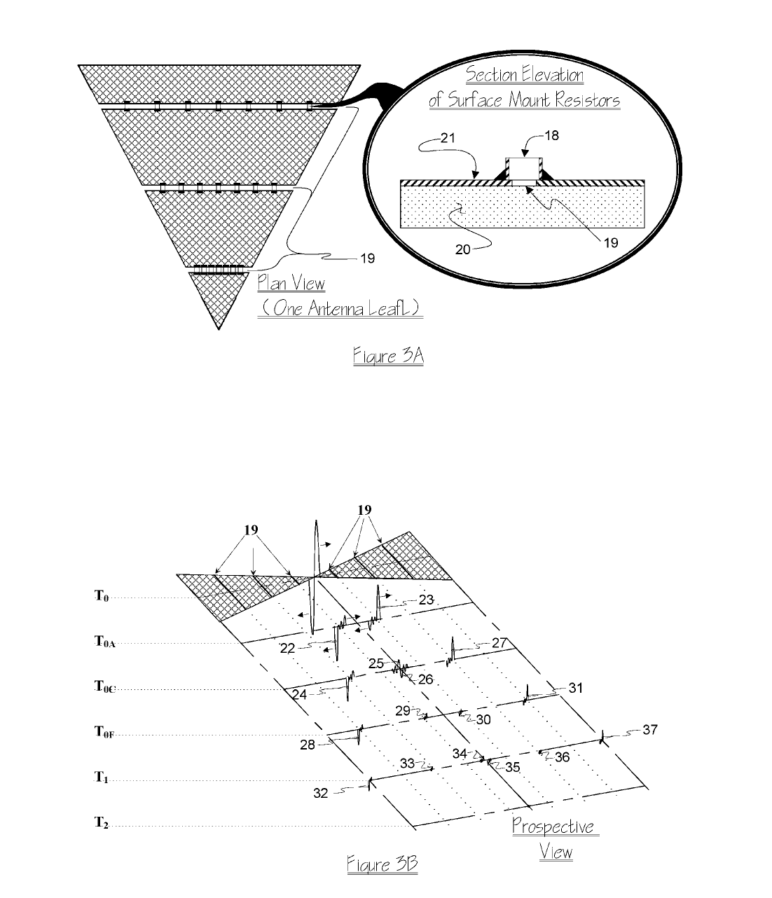

Impedance tapering has been used to suppress antenna ringing over the past 2 decades. The technique distributes parallel discrete bands of impedance material that are orthogonal to the direction of impulse flow across the antenna leaves to convert the ringing energy into heat at the expense of radiation efficiency. At the time of this disclosure, the most cost effective method to construct the impedance bands was by distributing surface mounted resistors across each gap. This is shown by example in FIG. 3A; a sectional view of the surface mount resistors 18, the conductive gap 19, the antenna substrate 20, and the conductive surface of the antenna 21 is shown in this figure to illustrate fabrication of the impedance bands when surface mount resistors are used. As previously noted, the impedance bands can be constructed of any material that alters or adds impedance to the conductive gap at each taper 6.

As impulse propagates toward the flare-end of each impedance tapered antenna leaf; a portion of the impulse energy is reflected toward the feed point at each of the impedance boundaries (22-24, 27, 28, and 31). The first impedance interface on any tapered antenna, shown by example at points 19 and 20, creates the highest reflected amplitude and consequently the highest amount of distortion interference to the rising edge of the transmitted impulse. The impulse energy is also attenuated by the resistive material at each impedance boundary (22-24, 27, 28, and 31). However, the reflected energy is also attenuated at each interface at points (25, 26, 29, 30, 33-36) as the impulse is iteratively reflected between the feed point and the flare ends at points 32 and 34 on the antenna. Accordingly, this antenna structure rapidly suppresses ringing and is well suited for systems that employ higher pulse-repetition frequencies and require improved receiver sensitivity in the near field.

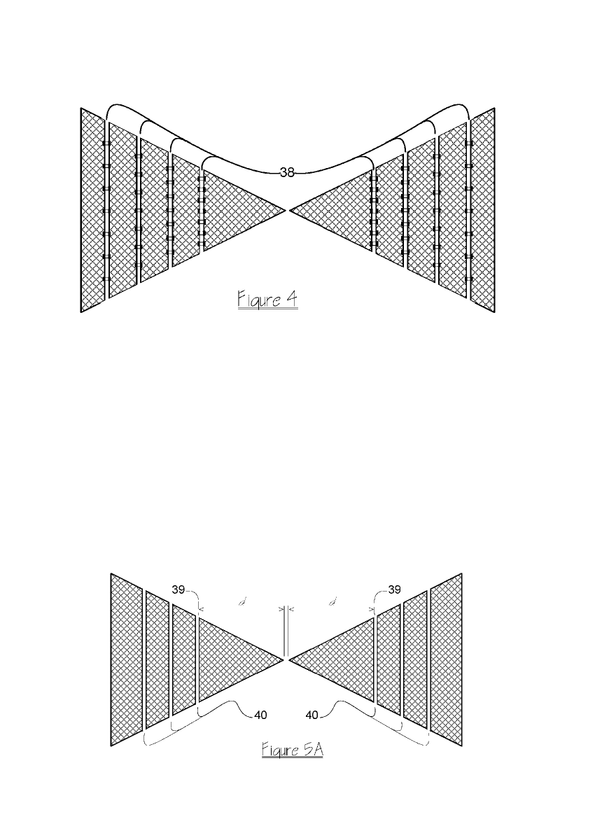

A fully assembled antenna with impedance tapering bands that are optimally placed to enhance antenna performance is shown in FIG. 5A. The critically placed first impedance band is positioned on the antenna at a distance d between the feed point and 39 so that the reflected energy that is created by this discrete interface at 39 arrives at the feed point when it will not distort the rising edge of the transmitted impulse. This invention completely eliminates antenna ringing in the return path from the flare end to the feed-point at points 41, 42, 46, 47, 50-53, and 55-58 shown in FIG. 5B while maintaining high radiation efficiency. Moreover, the marginal losses on the forward path 43, 44, 45, 48, 49, and 54 allow the transmitted impulse to largely retain its original shape and amplitude. Simulations and tests show that by positioning the first impedance band closer to latter half of the antenna as defined by the distance between the feed point and the flare-end of the antenna leaf, that radiation is only marginally degraded. Any antenna that is built in the impedance segmented fashion that is shown in FIG. 4, regardless of the geometry or impedance type used, where the bands are liked together by means of a continuous impedance material or by a series of discrete impedance materials such as resistors, and the bands are placed in the manner described above will suppress end-fire ringing without compromising radiation efficiency, the impedance characteristics of the antenna, or the front edge of the transmitted impulse signal.

1. Any antenna that is capable of transmitting an impulse signal and is of the type having impedance loaded tapered regions that are placed to minimize flare-end ringing and comprising in combination,
a. impedance tapered regions that are placed to optimally benefit end-flare ringing suppression and radiation efficiency;
b. separate conductive regions that are interconnected by any type of impedance material of any construction;
c. any geometric shape that is intended to radiate broadband signals;
d. that is constructed of any combination of conductive, resistive, dielectric, inductive, capacitive, or any other type of material that influences the characteristics of the antenna;
e. having any type of reflector or back-shield;
f. having the presence or absence of any type of lump loading between the antenna and the back-shield;
g. having the presence or absence of any type of lump loading between the antenna and ground;
h. any type of radar absorbing material surrounding the reflector and the antenna;
i. any type of dielectric surrounding the reflector and the antenna.

2. Any dipole, monopole, log periodic, circularly polarized, horn antenna, cylindrical, or any other operational antenna configuration of the type in claim 1.

3. Any multi-element antenna array of antennas of the type in claim 1, and claim 2.

4. Any antenna element of the type in claim 1, claim 2, and claim 3, with one or more tapered antenna leaves.

5. Any antenna of the type in claim 1, claim 2, claim 3, and claim 4 that has any number of tapered interfaces before or after the flare-end of the antenna.
